(19) United States
(12) Patent Application Publication
(10) Pub. No.: US 2007/0240184 A1
(43) Pub. Date: Oct. 11, 2007

(54) Digital Broadcasting Receiving Apparatus and Control Method Therefor

(76) Inventors: Koichi Terada, Kamakura (JP); Yoshihiro Shimizu, Yokohama (JP); Yoshifumi Izumi, Fujisawa (JP); Kazunori Iwabuchi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/695,649

(22) Filed: Apr. 3, 2007

(30) Foreign Application Priority Data
Apr. 11, 2006 (JP) 2006-108213

(51) Int. Cl. H04N 5/445

(52) U.S. Cl. 725/38

(57) ABSTRACT

Disclosed is a digital broadcasting receiving apparatus configured such that software served to control the behavior of the apparatus is divided into two pieces of software: a small piece of dedicated software (a) served to control a tuner and a large piece of software (b), i.e. main software, and that when the apparatus is switched on, the software (a) is first activated to perform received frequency setting, and in parallel with the receiving processes of the tuner, the software (b) is activated and executed. The apparatus can reduce the time required for a user to begin to watch images and listen to sounds after the apparatus is switched on.

### CROSS REFERENCE TO RELATED APPLICATION

This application claims priority from Japanese Patent Application JP2006-108213, filed on Apr. 11, 2006, the content of which is hereby incorporated by reference into this application.

### BACKGROUND OF THE INVENTION

The present invention relates to an information processing system for receiving digital broadcasts, and more particularly to technologies that are useful for developing a TV set and a DVD/HDD video recording STB set (STB for short hereafter) that have the function to receive HDTV digital broadcasting, a personal computer with a similar function (PC for short hereafter), and the like.

The digitalization of TV digital broadcasting has been progressing recently. Terrestrial digital broadcasting has been gaining momentum, not to mention satellite digital broadcasting. In the future, switching from analog TV broadcasting to digital TV broadcasting will be carried out as planned.

In association with the above mentioned trend, consumer audio-video devices, such as a TV set and a DVD/HDD video recording STB set, have been accommodated to digital broadcasting.

In addition, the function to receive and record TV broadcasts has become one of the important functions of a PC recently. This function can be implemented by mounting a tuner, etc. as components of the PC and allows users to watch images of TV broadcasts on the screen of the PC. In association with the performance improvement of PCs, a considerable number of PCs have been equipped with the function to receive TV broadcasts. PCs with the function to receive TV broadcasts have been gaining popularity among the general public because the functions that PCs essentially have, such as high-speed processing, high capacity storage, internet connection, and flexible user interface, can be utilized at the same time. And it goes without saying that PCs are required to have the function to receive digital broadcasts as is the case with TV sets.

On the other hand, various optional functions associated with digitalization, such as the function to record broadcasting contents and the function to receive data broadcasts as well as images and sounds, have been added to digital broadcasting receiving apparatuses, with the result that there is a tendency for starting up the apparatuses to take a long time.

There is a high tendency recently that the above-mentioned functions are implemented not by hardware such as dedicated LSIs, but by software that are executed by processors such as CPUs and DSPs.

For example, in the conventional art described in Japanese unexamined patent application publication (JP-A) No. 2003-115775, software of a digital broadcasting receiving apparatus is configured with two tasks that are activated in two stages separately. With the task to offer a partial service activated first, the partial service, that is, the TV broadcast receiving service can be offered to users in comparatively short time after the digital broadcasting receiving apparatus being started up.

### SUMMARY OF THE INVENTION

However, in the digital broadcasting receiving apparatuses configured in the above-mentioned conventional art, there are problems as follows:

Digital broadcasting is characterized in that it transmits images, sounds, and optional information after digitalizing them. At the broadcasting companies, data compression of images, sounds, and the like is carried out, and compressed data of images, sounds and pieces of optional information is multiplexed. After multiplexed data streams are modulated with the use of QAM or QPSK scheme, etc., the modulated streams are superimposed onto broadcast waves.

On the other hand, after receiving the broadcast waves, the digital broadcasting receiving apparatus offers information of images and sounds to users after a series of predefined procedures, such as demodulating the received broadcast waves, demultiplexing the multiplexed information to separate into individual components, and decompressing images and sounds.

As mentioned above, in the digital broadcasting receiving apparatuses, there are complex procedures during the interval from receiving broadcast waves to offering images and sounds to users, with the result that there a problem in that it takes a long time to carry out the above-mentioned processes. Therefore, owing to this problem, there is also a problem in that it takes a long time for users to become able to watch TV programs after switching on TV sets. Especially in PCs, because application programs control the function to receive digital broadcasts after OS is booted up, the above-mentioned problem is more serious.

Accordingly, it is one of the objects of the present invention to solve the problem peculiar to a digital broadcasting receiving apparatus in that it takes a long time for users to become able to watch images and listen to sounds, and more particularly to provide a digital broadcasting receiving apparatus that enables users to watch digital broadcasts in a short time after the digital broadcasting receiving apparatus being switched on.

The conventional art described in JP-A-2003-115775 enables users to watch images and listen to sounds before other optional functions such as the function requiring authentication of a user ID are booted up by separating the function to enable users to watch images and listen to sounds as a partial function. However, it does not have such a beneficial effect on reducing the time itself that is required for users to become able to watch images and listen to sounds as the present invention has.

One of the objects of the present invention is to provide a solution for the above-mentioned problems. The outlines of the representative embodiments the present invention discloses will be described below.

Software of a digital broadcasting receiving apparatus can be configured with a first part of software that controls the functions of a tuner module and a second part of software that controls the functions other than those of the tuner module, wherein the first part of software is booted up earlier than the second part of software.

The present invention provides a digital broadcasting receiving apparatus that can solve the problem peculiar to this kind of apparatus in that it takes a long time for users to become able to watch images and listen to sounds after the apparatus is switched on.

### BRIEF DESCRIPTION OF THE DRAWINGS

FIG. 1 is a block diagram showing a configuration of a digital broadcasting receiving apparatus related to an embodiment of the present invention;

FIG. 2 is a block diagram showing an internal configuration of a DSP module of the digital broadcasting receiving apparatus related to the embodiment of the present invention;

FIG. 3 is a timing sequence diagram explaining the start-up behavior of the digital broadcasting receiving apparatus related to the embodiment of the present invention after the apparatus is switched on;

FIG. 4 is a timing sequence diagram explaining the start-up behavior of a digital broadcasting receiving apparatus not related to the embodiment of the present invention after the apparatus is switched on;

FIG. 5 is an operational flowchart showing the behavior of a bootloader means of the digital broadcasting receiving apparatus related to the embodiment of the present invention;

FIG. 6 is an operational flowchart showing the behavior of frequency setting software of the digital broadcasting receiving apparatus related to the embodiment of the present invention; and

FIG. 7 is an operational flowchart showing the behavior of main software of the digital broadcasting receiving apparatus related to the embodiment of the present invention.

### DESCRIPTION OF THE PREFERRED EMBODIMENTS

The preferred embodiments of the present invention will be described in detail hereafter with reference to the attached drawings. Through all the figures for describing the embodiments of the present invention, the same components are given the same reference numerals, and the same descriptions about the same components will not be repeated.

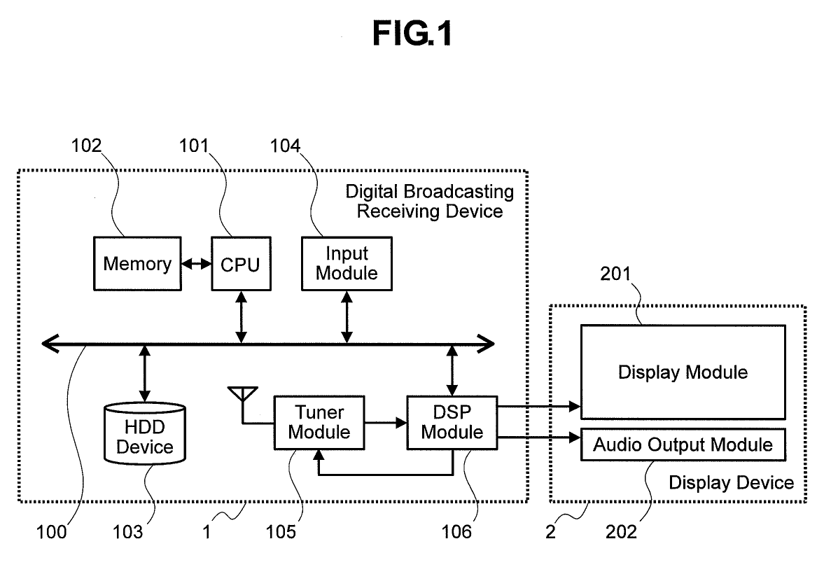

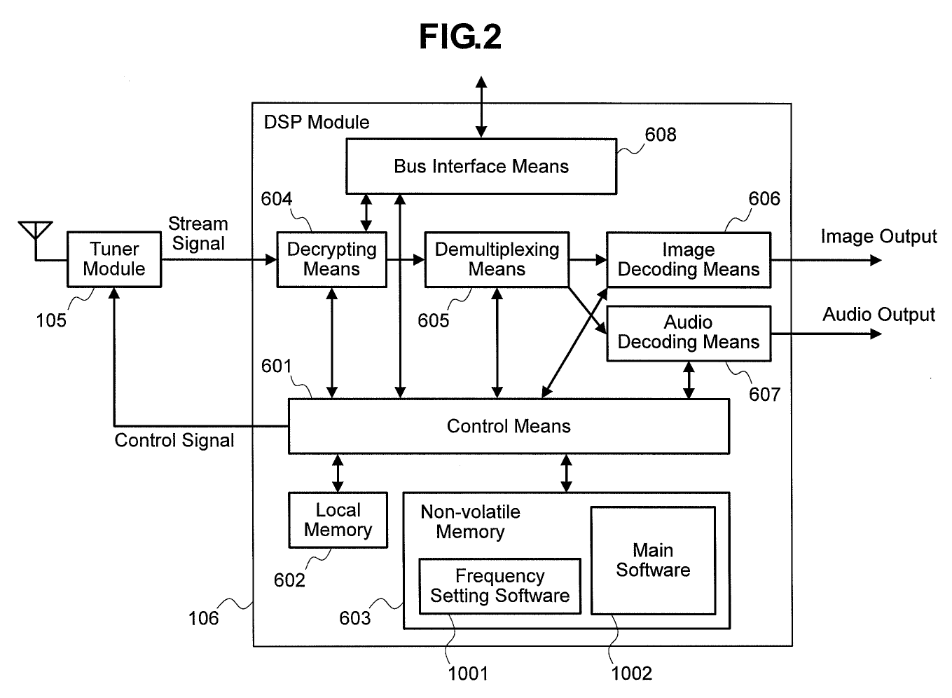

A configuration of a digital broadcasting receiving apparatus related to an embodiment of the present invention will be described with reference to FIG. 1 and FIG. 2. FIG. 1 is a block diagram showing a configuration of the digital broadcasting receiving apparatus related to an embodiment of the present invention.

As shown in FIG. 1, the digital broadcasting receiving apparatus includes a digital broadcasting receiving device 1 and a display device 2.

The digital broadcasting receiving device 1 includes a CPU 101; a memory 102, which is a main memory; a hard disk drive 103, which is an auxiliary storage device (HDD device for short hereafter); an input module 104, which is equipped with an infrared remote controller; a tuner module 105, which receives digital broadcasting signals; and a DSP module 106, which converts HDTV broadcasting signals to image signals. Most of these components are connected with each other via a bus 100.

In FIG. 1, the CPU 101 and the memory 102 are shown to be individual components, but it is not necessarily the case that they are individual components. They can be included in a single part in such a way that they perform individual functions. In a similar way, components shown in Figs. as individual components are not always needed to be individual components. They can be combined with other components shown in Figs.

The display device 2 includes a display module 201 such as a liquid crystal panel or a plasma display panel, and an audio output module 202 such as a speaker device.

FIG. 2 is a block diagram showing the internal configuration of the DSP module 106 of the digital broadcasting receiving apparatus related to the embodiment of the present invention;

The internal configuration shown in FIG. 2 is not necessarily needed to include only hardware components, but can include software components or a combination of hardware components and software components.

As shown in FIG. 2, the DSP module 106 includes a control means 601, which controls the behavior of the DSP; a local memory 602, which is used for executing the software for the DSP; a non-volatile memory 603, which holds the software for the DSP during the power-off period; a decrypting means 604, which decrypts encrypted stream signals that are digital broadcasting signals; a demultiplexing means 605, which demultiplexes the decrypted stream signals to image streams and audio streams; an image decoding means 606, which converts the image streams into image signals; an audio decoding means 607, which converts the audio streams into audio signals; and a bus interface means 608, which connects the DSP module 106 to other components that constitute the digital broadcasting receiving device 1.

A behavior of the digital broadcasting receiving apparatus related to the embodiment of the present invention will be described with reference to FIG. 1. When the input module 104 receives a user's input, the CPU 101 begins to control the whole behavior of the digital broadcasting receiving device 1 via the bus 100 according to contents of the direction indicated by the user's input. The behavior of the apparatus will be described below under the assumption that channel switching is directed by a user.

After receiving the receiving direction from the input module 104, the CPU 101 firstly sends a direction to the tuner module 105 via the DSP module 106 so that the channel desired by the user can be selected. The tuner module 105 selects the suitable frequency band according to the contents of the direction, receives broadcast waves, carries out necessary signal processing onto the received broadcast waves, and then sends the resultant signals to the DSP module 106 in the form of compressed digital image/audio signals.

In addition, the CPU 101 sends a direction to the DSP module 106 so that the DSP module 106 receives signals from the tuner module 105 and creates images. The DSP module 106 receives the compressed digital image/audio signals, which is the so-called stream signals, from the tuner module 105, and then converts them into the formats that can be perceived by human beings. In other words, the DSP module 106 performs video decoding processing and audio decoding processing onto the stream signals. Image signals obtained after the video decoding process and audio signals obtained after the audio decoding process are sent to the display device 2.

The above-mentioned behavior of the digital broadcasting receiving apparatus allows images currently broadcast to be displayed on the display device 201 and sounds currently broadcast to be output from the audio output module 202. As the result, the user is provided with the images and the sounds.

Next, the internal behavior of the DSP module 106 of the digital broadcasting receiving apparatus related to the embodiment of the present invention will be described with reference to FIG. 2.

The behavior of the DSP 106 will be described below under the assumption that the direction to select the channel desired by the user is sent to the DSP 106 by the CPU 101.

The direction from the CPU 101 is received by the control means 601 via the bus 100 and the bus interface means 608.

The control means 601 sends a direction to the tuner module 105 so that the tuner module 105 selects the suitable frequency band, receives the broadcast waves, performs necessary signal processing, and sends the compressed digital image/audio signals to the DSP module 106.

The control means 601 sends suitable directions to the decrypting means 604, the demultiplexing means 605, the image decoding means 606, and the audio decoding means 607 respectively, with the result that the digital image/audio signals sent from the tuner module are converted into image signals/audio signals, and sent to the display device 2 in order for the user to watch the images and listen to the sounds.

Through the above-mentioned behavior, the digital broadcasting receiving apparatus provides a function to allow the user to watch the desired channel.

Another behavior of the digital broadcasting receiving apparatus related to the embodiment of the present invention will be described with reference to FIG. 1 and FIG. 2.

The behavior of the apparatus will be described below under the assumption that an image recording is directed by a user.

The CPU 101 firstly sends a direction to the tuner module 105 so that a channel desired by the user can be selected in a similar way as the above-mentioned receiving behavior of the apparatus.

The tuner module 105 selects the suitable frequency band, receives broadcast waves, performs necessary signal processing, and sends the compressed digital image signals to the DSP module 106. The DSP module re-encrypts the received compressed image signals and sends them to the bus 100. After receiving the signals, the CPU 101 sends them to the HDD device 103, where they are stored as image recording data files.

The internal behavior of the DSP module during the image recording will be described with reference to FIG. 2.

Firstly, after receiving the encrypted broadcasting signals, the decrypting means 604 decrypts the encrypted broadcasting signals and convert them to plain texts. During the image recording, the decrypting means 604 performs re-encrypting process on the signals using a local encryption key unique to the digital broadcasting receiving apparatus (not shown in FIG. 2) and outputs the re-encrypted signals to the bus 100.

Image recording does not always means recording current broadcasts but it often means recording broadcasts that will be aired during specified time slots in the future, and that is called advance image recording. In the case where the direction of advance image recording is given by a user, the image recording is performed during the specified time slot directed by the user with the CPU 101 mainly controlling the image recording.

Next, the behavior of the broadcasting receiving apparatus will be described below under the assumption that reproducing of an image recording data file that was recorded before is directed by a user.

After receiving the direction of reproducing from the input module 104, the CPU 101 sends a direction to the HDD device 103 to retrieve the image recording data file. The data of the image recording data file is sent to the DSP module 106 via the bus 100.

In addition, the CPU 101 sends a direction to the DSP module 106 so that the DSP module 106 receives data from the CPU and creates images. The DSP module 106 receives the compressed digital image signals from the CPU 101, and then decodes them. The behavior of the apparatus hereafter is similar as the above-mentioned broadcast receiving behavior of the apparatus.

The internal behavior of the DSP 106 during the reproducing will be described with reference to FIG. 2.

After receiving the encrypted image information sent from the CPU 101 via the bus 100, the decrypting means 604 decrypts the encrypted image information using the local encryption key unique to the digital broadcasting receiving apparatus and sends the decrypted image information to the demultiplexing means 605.

Local encryption keys unique to apparatuses are given to individual apparatuses as unique numerical values when they are shipped so that there are no apparatuses that have the same local encryption keys. Therefore, in the case where a broadcast is recorded in an apparatus a, the HDD device of the apparatus a is removed and the HDD device is connected to an apparatus b, the recorded images can not be reproduced in the apparatus b. With the use of encryption keys unique to apparatuses, broadcast images can be protected from unauthorized use.

In the above-mentioned descriptions, it is assumed that broadcast receiving, broadcast recording, and broadcast reproducing behaviors occur individually, but it goes without saying that they can occur in parallel. For example, recording and reproducing behaviors can be carried out at the same time. In other words, recording behavior can be carried out as so called background recording.

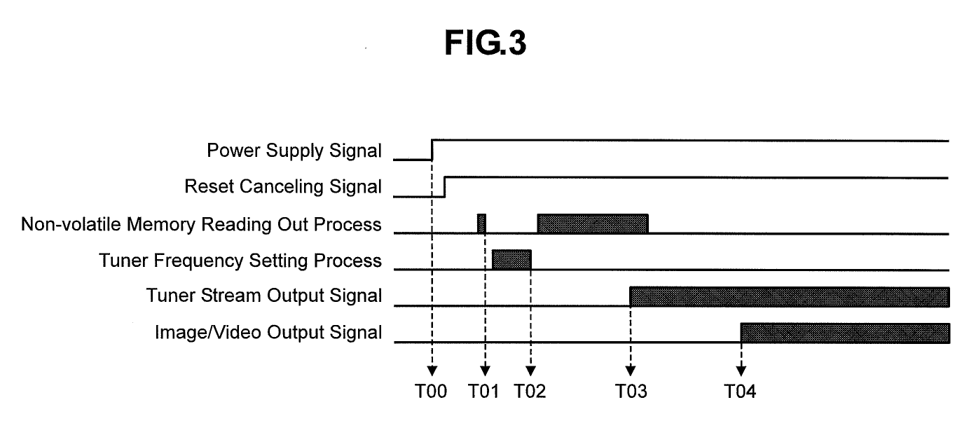

Another behavior of the digital broadcasting receiving apparatus related to the embodiment of the present invention will be described with reference to FIG. 1, FIG. 2 and FIG. 3.

The behaviors of the system of the digital broadcasting receiving apparatus after the apparatus is switched on will be described in detail.

Behaviors of the components of the digital broadcasting receiving apparatus will be described with reference to FIG. 1 and FIG. 2.

When the digital broadcasting receiving apparatus is switched on, the components of the digital broadcasting receiving device 1 are supplied with power, and begin the start-up processes.

After being supplied with power, the DSP module 106 first performs the control means initialization process, etc., and then reads out a series of software stored in the volatile memory 603. The DSP module 106 expands these series of software into the local memory 602 and executes them. Software stored in the volatile memory 603 includes frequency setting software 1001 used to set frequency bands for the tuner module 105 and main software 1002 used to provide various services.

Next, the operating timings of the components of the digital broadcasting receiving apparatus will be described with reference to FIG. 3.

FIG. 3 is a timing sequence diagram explaining the start-up behavior of the digital broadcasting receiving apparatus related to the embodiment of the present invention after the digital broadcasting receiving apparatus is switched on.

FIG. 3 shows the operating timings of a power supply signal, a reset canceling signal, non-volatile memory reading out process, tuner frequency setting process, a tuner stream output signal, and an image/video output signal.

After the power supply signal is asserted, the components begin to be supplied with power. The following description will be given under the assumption that the time when the power supply signal is asserted is T00.

Next, the reset canceling signal is asserted, and the reset status of the whole system is canceled.

Then the non-volatile memory reading out process begins to be performed. The frequency setting software and the main software are stored in the non-volatile memory, and the former can be set very small in size than the latter.

Firstly, the frequency setting software is read out, and the tuner frequency setting process is performed. Let us suppose that the time when the frequency setting software begins to be performed is T01 and the time when the tuner frequency setting process is completed is T02. As mentioned above, because the frequency setting software is very small in its physical size, reading out the software from the non-volatile memory is completed in a short time.

Next, the non-volatile memory reading out process is performed, the main software is read out, and the main software is booted up.

On the other hand, after completing the frequency setting process, the tuner module 105 performs its internal processes independent of the main software and when being ready to output tuner stream output signals, the tuner module 105 outputs the signals. Let us suppose that the time when the tuner module 105 begins to output the tuner stream output signals is T03.

When the tuner stream output signals are output and the main software is activated, the main software begins the decoding process of image/audio signals and outputs the image/audio output signals. Let us suppose that the time when the main software begins to decode the image/audio signals and outputs image/audio output signals is T04.

A tuner for digital broadcasting is characterized in that it takes a certain length of waiting time for the tuner to begin to output image/audio stream signals after completing the frequency setting process. This is due to the fact that stream transmission methods adopted in digital broadcasting are configured with technologies to minimize the adverse effect of burst errors to image/audio signals. For example, it is theoretically impossible for the stream transmission methods to extract a stream without detecting a time frame with a certain time length. Therefore, it always takes about twice the time length of the time frame for the tuner to begin to output image/audio stream signals after completing the frequency setting process.

In FIG. 3, this waiting time Tw1 is expressed as Tw1=T03−T02. Generally this waiting time Tw1 is 1 to 3 seconds depending on the performance of tuners used for digital broadcasting.

As mentioned above, users can watch images and listen to sounds in the time Twa1 after the digital broadcasting receiving apparatus is switched on, where Twa1=T04−T00.

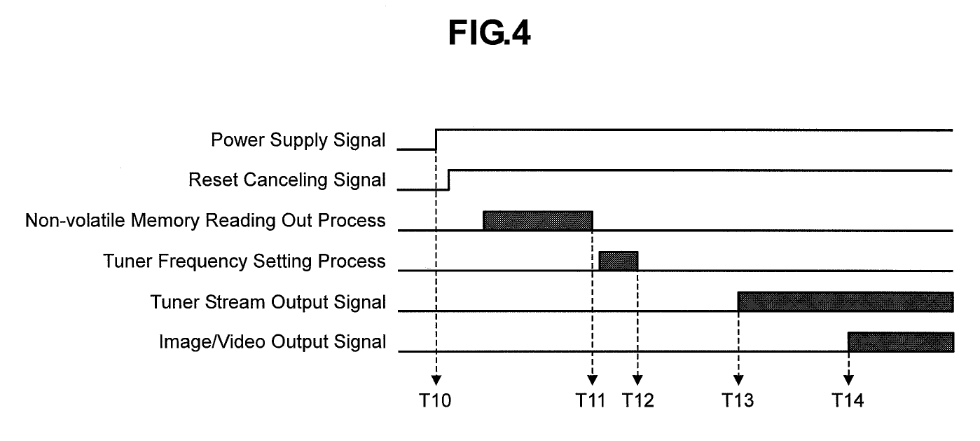

Next, operating timings of components of a conventional digital broadcasting receiving apparatus not related to the embodiment of the present invention will be described with reference to FIG. 4.

FIG. 4 is a timing sequence diagram explaining the start-up behavior of the conventional digital broadcasting receiving apparatus not related to the embodiment of the present invention after the apparatus is switched on.

In a similar way as FIG. 3, FIG. 4 shows the operating timings of a power supply signal, a reset canceling signal, a non-volatile memory reading out process, a tuner frequency setting process, a tuner stream output signal, and an image/video output signal.

After the power supply signal is asserted, components begin to be supplied with power. The following description will be given under the assumption that the time when the power supply signal is asserted is T10.

Next, the reset canceling signal is asserted, and the reset status of the whole system is canceled.

Then the non-volatile memory reading out process begins to be performed. Main software is stored in a non-volatile memory. Firstly, the main software is read out from the non-volatile memory, and the frequency setting process is performed. Let us suppose that the time when the main software begins to be performed is T11 and the time when the frequency setting process is completed is T12.

After completing the frequency setting process, the tuner module 105 performs its internal processes independently of the main software and when being ready to output the tuner stream output signals, the tuner module 105 outputs the signals. Let us suppose that the time when the tuner module 105 begins to output the tuner stream output signals is T13.

When the tuner stream output signals are output and the main software is activated, the main software begins to decode the image/audio signals and outputs image/audio output signals. Let us suppose that the time when the main software begins to decode the image/audio signals and outputs image/audio output signals is T14.

In FIG. 4, the time length, Tw2, of waiting time for the tuner to begin to output image/audio stream signals after completing the frequency setting process onto the tuner for digital broadcasting is expressed as Tw2=T13−T12. If the circumstances of the tuner, etc. in FIG. 4 are the same as those in FIG. 3, the value of Tw2 is equal to that of Tw1 in FIG. 3, where Tw1=T03−T02.

On the other hand, as shown in the operating timings of FIG. 4, users can watch images and listen to sounds in the time Twa2 after the digital broadcasting receiving apparatus is switched on, where Twa2=T14−T10. The value of Twa2 is larger than that of Twa1 in FIG. 3.

This is due to the fact that the main software cannot perform the decoding process during the time interval between the time point T11 when the main software has been already activated and the time point T13 when the stream signals begin to be output from the tuner. In other words, the main software has nothing to do but wait during the above-mentioned time interval because image/audio signals are not output.

As described above, the conventional digital broadcasting receiving apparatus takes a longer time to provide users with image/audio signals after being switched on than the digital broadcasting receiving apparatus related to the embodiment of the present invention.

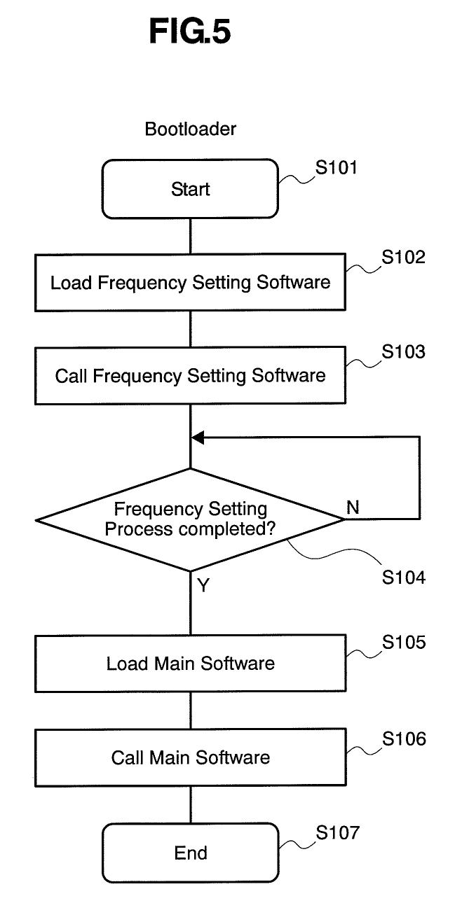

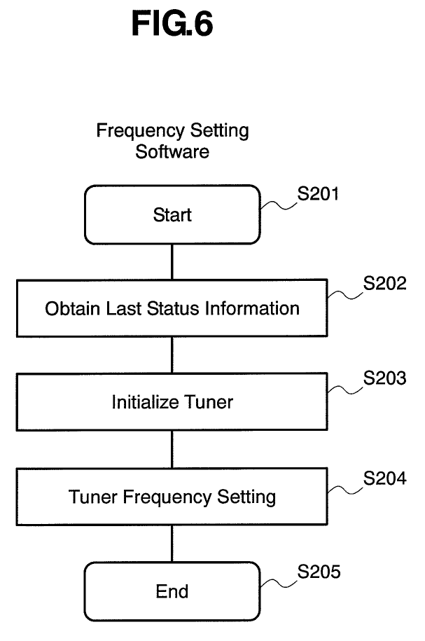

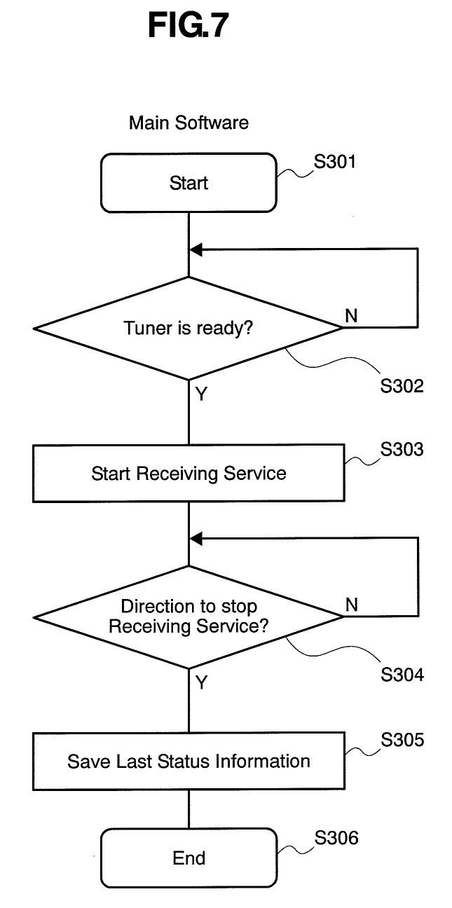

Next, the operational flows of the digital broadcasting receiving apparatus related to the embodiment of the present invention will be described with reference to FIG. 5, FIG. 6, and FIG. 7.

The behavior of the system of the digital broadcasting receiving apparatus after the apparatus is switched on will be described in detail.

FIG. 5 is an operational flowchart showing the behavior of the bootloader means of the digital broadcasting receiving apparatus related to the embodiment of the present invention.

FIG. 6 is an operational flowchart showing the behavior of frequency setting software of the digital broadcasting receiving apparatus related to the embodiment of the present invention.

FIG. 7 is an operational flowchart showing the behavior of main software of the digital broadcasting receiving apparatus related to the embodiment of the present invention.

Firstly, the behavior of the bootloader means will be described with reference to FIG. 5. The bootloader means can be a simple hardware component, a simple software component or a combination of a hardware component and software components embedded in the digital broadcasting receiving apparatus (not shown in Figs.), and used for reading out other sophisticated pieces of software from the non-volatile memory 603 and storing them in the local memory 602. In the configuration of the digital broadcasting receiving apparatus related to the embodiment of the present invention, the behavior of the apparatus will be described under the assumption that the bootloader means is embedded in the control means 601, but the present invention is not limited to this specific configuration.

After the bootloader means is activated at Step 101, the bootloader means loads the frequency setting software from the non-volatile memory onto the local memory at Step 102. After completing loading the frequency setting software, the bootloader means calls the frequency setting software stored in the local memory and begins the frequency setting process at Step 103. After completing the frequency setting process at Step 104, the bootloader means loads the main software from the non-volatile memory onto the local memory at Step 105. After completing loading the main software, the bootloader means calls the main software stored in the local memory at Step 106.

Next, the behavior of the frequency setting software will be described with reference to FIG. 6.

As mentioned above, the frequency setting software can be implemented as very small software in its physical size. A small size of the frequency setting software can be realized by implementing only the function of frequency setting in the frequency setting software and implementing other necessary functions in the main software.

After the frequency setting software is activated at Step 201, the frequency setting software obtains the last status information at Step 202. The last status information includes information about the statuses under which the digital broadcasting receiving apparatus was used the last time such as the channel number used the last time, the sound volume value set at the last time. Let us suppose that the last status information is saved in the non-volatile memory 603 this time. The last status information can includes information about various statuses of the digital broadcasting receiving apparatus that can be changed by users other than the above-mentioned statuses.

Next, the frequency setting software performs the tuner initialization process at Step 203 and the tuner frequency setting process at Step 204 based on the obtained last status information.

When the above-mentioned processes are completed, the frequency setting software stops at Step 205.

The tuner module 105 selects the specified frequency band, receives the broadcast waves, and begins to operate in order to output tuner stream signals in accordance with the above-mentioned processes. This operation of the tuner is performed independent of the termination processing of the frequency setting software or the boot up process of the main software.

Next, the behavior of the main software will be described with reference to FIG. 7.

The main software is implemented as larger software in physical size than the above-mentioned frequency setting software.

After the main software is activated at Step 301, the main software queries the tuner module 105 at Step 302. If the frequency setting has been completed and the tuner stream signals begins to be output in the tuner module 105, that is, if the tuner is ready, the tuner module returns the signal meaning that the tuner is ready.

After receiving the signal meaning that the tuner is ready from the tuner module 105, the main software begins to carry out decoding process of stream signals, etc. at Step 303 to provide a user with the broadcast receiving service, that is, the service to provide the user with image/audio signals.

Next, if the main software receives the direction to stop the broadcast receiving service from the user at Step 304, the main software begins to perform the saving process of the last status information in order to record the current channel number and so on at Step 305. Here, it is assumed that the last status information is saved in the non-volatile memory 603 as mentioned-above.

When recording of the last status information is completed, the main software stops at Step 306.

The digital broadcasting receiving apparatus with the above-mentioned operational flow enables users to watch images and listen to sounds in a short time after being switched on.

Although the present invention has been particularly described based on its preferred embodiments, it goes without saying that the present invention is not limited to the above-mentioned embodiments and that various changes and variations may be made without departing from the spirit and scope of the present invention.

For example, in the specification of the present invention, the main software 1002 is assumed to be a large piece of software, but this is not always necessary. This is for simplification of the description. The main software can be a combination of many pieces of software.

In addition, in the specification of the present invention, it is assumed that the frequency setting software selects the channel number that was selected the last time by a user using the last status information. However the behavior of the frequency setting software is not limited to such a behavior as this. For example, the frequency setting software can select the channel number that is specified by a certain button when the frequency setting software is booted up and detects that the button is pushed by a user. These detection process and channel selection process are performed by the CPU 101.

In addition, the above mentioned embodiment can be modified to adapt to a receiving apparatus with multiple tuners mounted. For example, if a digital broadcasting receiving apparatus is equipped with two tuners, that is, a tuner 1 and a tuner 2, comparatively small two pieces of dedicated software to control tuner 1 and tuner 2 can be implemented. And they can be directed to boot up and set receiving frequency bands in advance via the CPU 101.

In another modification, the tuner 1 can be activated in advance and the tuner 2 can be kept from being activated until a user directs the tuner 2 to be activated. Or the tuner to be activated in advance can be selected by a user.

In addition, in FIG. 1 for example, the description about the embodiment of the present invention has been made under the assumption that the digital broadcasting receiving device and the display device are included in individual bodies, but they can be included in one body.

The technologies that have been disclosed above can be applied to an information processing system for receiving digital broadcasts, and more particularly to a TV set and a DVD/HDD video recording STB set that have the function to receive HDTV digital broadcasts, and to a personal computer with a similar function and the like.

1. A digital broadcasting receiving apparatus for receiving digital broadcasts, comprising:
a receiving module configured to receive stream signals of digital broadcasts;
an image/audio processing module configured to demultiplex the stream signals received by said receiving module into image streams and audio streams, and to output the image signals and the audio signals after decoding said image streams and said audio streams;
a memory module configured to include first software served to control said receiving module and second software served to control said image/audio processing module; and
a behavior control module configured to control said receiving module and said image/audio processing module by loading and starting up said first software from said memory module and subsequently loading and starting up said second software from said memory module.

2. The apparatus according to claim 1, wherein
said first software has a function of frequency setting for said receiving module; and
said behavior control module operates to load said first software from said memory module and allow said first software to perform frequency setting for said receiving module when the digital broadcasting receiving apparatus is switched on.

3. The apparatus according to claim 2, wherein
said memory module configured to store a channel number of a frequency band that was used the last time; and
said behavior control module operates to load said first software from said memory module and allow said first software to perform frequency setting for said receiving module in accordance with the channel number stored in said memory module when the digital broadcasting receiving apparatus is switched on.

4. The apparatus according to claim 2, further comprising
an operation input module where a channel number is input by a user, wherein
said behavior control module operates to load said first software from said memory module and allow said first software to perform frequency setting for said receiving module in accordance with a channel number input from said operation input module when the digital broadcasting receiving apparatus is switched on.

5. The apparatus according to claim 1, wherein
said second software has a function to detect stream signals output from said receiving module and begin to decode the stream signals; and
said behavior control module controls said image/audio processing module to convert said stream signals into image signals and audio signals and output the image signals and the audio signals after said streams signals are output from said receiving module.

6. A digital broadcasting receiving apparatus for receiving digital broadcasts, comprising:
a receiving module configured to receive stream signals of a set broadcast channel;
a decrypting module configured to decrypt encrypted stream signals sent from said receiving module;
a demultiplexing means configured to demultiplex the decrypted stream signals to image streams and audio streams;
an image decoding means configured to convert said demultiplexed image signals into image signals;
an audio decoding means configured to convert said demultiplexed audio signals into audio signals; and
a control module configured to control behaviors of said receiving module, said decrypting module, said demultiplexing means, said audio decoding means and image decoding means, wherein
said control module operates to send an initialization direction to said receiving module and subsequently perform a channel setting of said receiving module when the digital broadcasting receiving apparatus is switched on.

7. The apparatus according to claim 6, wherein
said control module operates to confirm that said streams signals can be output from said receiving module onto which the channel setting has been performed and subsequently control behaviors of said decrypting module, said demultiplexing means, said audio decoding means and image decoding means so as to convert said stream signals into image streams and audio streams for output.

8. A receiving control method for a digital broadcasting receiving apparatus for receiving digital broadcasts, comprising:
reading out first software that controls a receiving module that receives stream signals of digital broadcasts from a memory module;
beginning to perform received frequency setting of said receiving module by executing said first software;
reading out second software that controls an image/audio processing module that demultiplexes stream signals received by said receiving module into image streams and audio streams, and outputs image signals and audio signals after decoding said image streams and said audio streams;
confirming that the stream signals have been output from said receiving module by executing said second software; and
demultiplexing the stream signals received by said receiving module into image streams and audio streams, and decodes image signals and audio signals for output.

9. The method according to claim 8, further comprising:
recording a channel number corresponding to a broadcast frequency band watched by a user in a volatile memory module when the digital broadcasting receiving apparatus stops; and
obtaining the channel number recorded in said volatile memory module so as to begin to perform received frequency setting of said receiving module.

10. The method according to claim 8, further comprising:
obtaining a channel number specified by a user's operation; and
beginning to perform received frequency setting of said receiving module in accordance with said channel number.
